(19) United States
(12) Patent Application Publication
(10) Pub. No.: US 2015/0244548 A1
(43) Pub. Date: Aug. 27, 2015

(54) FREQUENCY ADJUSTMENT OF SIGNALS

(71) Applicant: QUALCOMM Incorporated, San Diego, CA (US)

(72) Inventors: Haim Mendel Weissman, Haifa (IL); Lior Raviv, Atlit (IL); Yossef Tsfaty, Rishon-Le-Zion (IL)

(73) Assignee: QUALCOMM Incorporated, San Diego, CA (US)

(21) Appl. No.: 14/192,538

(22) Filed: Feb. 27, 2014

(51) Int. Cl. H04L 27/00; H04B 17/00; H04L 12/24

(52) U.S. Cl. CPC H04L 27/0002; H04L 41/24; H04B 17/0082

(57) ABSTRACT

An apparatus includes a modulator configured to frequency modulate a control signal at a baseband device and an interface configured to transmit the frequency modulated control signal via a cable to a radio-frequency (RF) device.

### I. FIELD

The present disclosure is generally related to signals transferred between a radio frequency device and a non-radio frequency device.

### II. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and Internet protocol (IP) telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can process executable instructions, including software applications, such as a web browser application, that can be used to access the Internet. As such, these wireless telephones can include significant computing capabilities.

Wireless telephones may include various transceivers to support multiple wireless communication standards, such as Institute of Electrical and Electronics Engineers (IEEE) 802.11-type standards (e.g., Wi-Fi), cellular standards such as Long Term Evolution (LTE), Global System for Mobile Communications (GSM), etc., global positioning system (GPS)-type standards, near field communications (NFC)-type standards, and frequency modulation (FM) radio, as illustrative examples. Wireless telephones may also include transceivers for wired communications, such as high-speed serial buses. Use of multiple wireless and wired transceivers in a single device results in mutual electromagnetic interference between the transceivers that may degrade signal and link quality of one or more of the transceivers.

### III. BRIEF DESCRIPTION OF THE DRAWINGS

FIG. 1 shows a wireless device communicating with a wireless system;

FIG. 2 shows a block diagram of the wireless device in FIG. 1;

FIG. 3 is a block diagram that depicts a first exemplary embodiment of a system that is operable to adjust a frequency of a signal communicated between a baseband/intermediate frequency (BB/IF) device and a radio frequency (RF) device;

FIG. 4 is a diagram that depicts an exemplary embodiment of a spectrum of signals communicated between the BB/IF device and the RF device of FIG. 3;

FIG. 5 is a block diagram that depicts a first exemplary embodiment of a modulation circuit that can be used in the BB/IF device of FIG. 3;

FIG. 6 is a block diagram that depicts a second exemplary embodiment of a modulation circuit that can be used in the BB/IF device of FIG. 3;

FIG. 7 is a block diagram that depicts a second exemplary embodiment of a system that is operable to adjust a frequency of a signal communicated between a baseband/intermediate frequency (BB/IF) device and a radio frequency (RF) device;

FIG. 8 is a diagram that depicts an exemplary embodiment of a spectrum of signals communicated between the BB/IF device and the RF device of FIG. 7;

FIG. 9 is a block diagram that depicts a third exemplary embodiment of a system that is operable to adjust a frequency of a signal communicated between a baseband/intermediate frequency (BB/IF) device and a radio frequency (RF) device; and

FIG. 10 is a flowchart that illustrates an exemplary embodiment of a method of frequency adjusting signals.

### IV. DETAILED DESCRIPTION

The detailed description set forth below is intended as a description of exemplary designs of the present disclosure and is not intended to represent the only designs in which the present disclosure can be practiced. The term “exemplary” is used herein to mean “serving as an example, instance, or illustration.” Any design described herein as “exemplary” is not necessarily to be construed as preferred or advantageous over other designs. The detailed description includes specific details for the purpose of providing a thorough understanding of the exemplary designs of the present disclosure. It will be apparent to those skilled in the art that the exemplary designs described herein may be practiced without these specific details. In some instances, well-known structures and devices are shown in block diagram form in order to avoid obscuring the novelty of the exemplary designs presented herein.

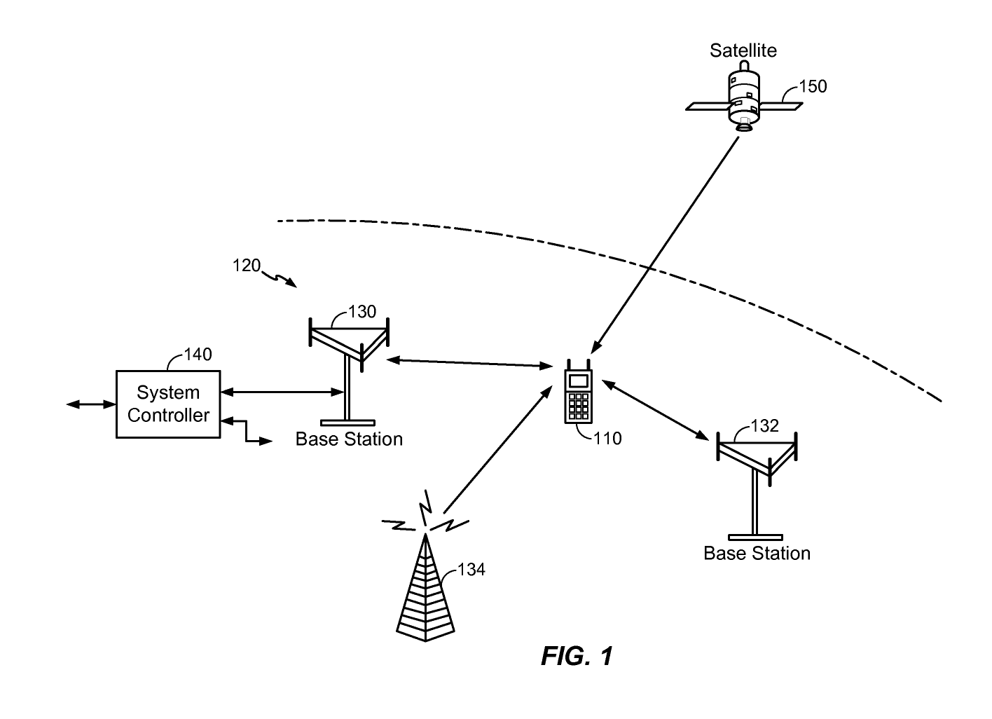

FIG. 1 shows a wireless device 110 communicating with a wireless communication system 120. Wireless communication system 120 may be a Long Term Evolution (LTE) system, a Code Division Multiple Access (CDMA) system, a Global System for Mobile Communications (GSM) system, a wireless local area network (WLAN) system, or some other wireless system. A CDMA system may implement Wideband CDMA (WCDMA), CDMA 1X, Evolution-Data Optimized (EVDO), Time Division Synchronous CDMA (TD-SCDMA), or some other version of CDMA. For simplicity, FIG. 1 shows wireless communication system 120 including two base stations 130 and 132 and one system controller 140. In general, a wireless system may include any number of base stations and any set of network entities.

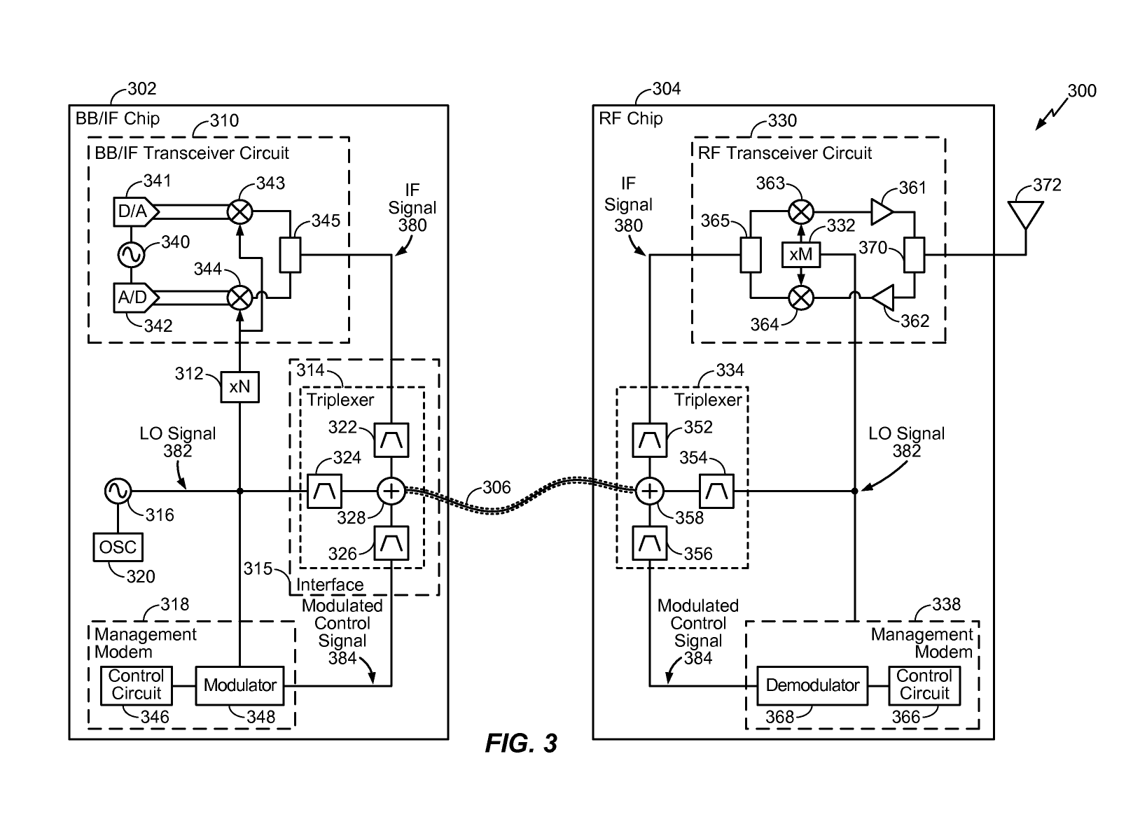

Wireless device 110 may also be referred to as a user equipment (UE), a mobile station, a terminal, an access terminal, a subscriber unit, a station, etc. Wireless device 110 may be a cellular phone, a smartphone, a tablet, a wireless modem, a personal digital assistant (PDA), a handheld device, a laptop computer, a smartbook, a netbook, a cordless phone, a wireless local loop (WLL) station, a Bluetooth device, etc. Wireless device 110 may communicate with wireless system 120. Wireless device 110 may also receive signals from broadcast stations (e.g., a broadcast station 134), signals from satellites (e.g., a satellite 150) in one or more global navigation satellite systems (GNSS), etc. Wireless device 110 may support one or more radio technologies for wireless communication such as LTE, WCDMA, CDMA 1x, EVDO, TD-SCDMA, GSM, 802.11, etc. To avoid or reduce mutual interference between transceivers at the wireless device 110, the wireless device 110 is operable to adjust a frequency of a signal communicated between a baseband/intermediate frequency (BB/IF) device and a radio frequency (RF) device, such as described in further detail with respect to FIG. 3.

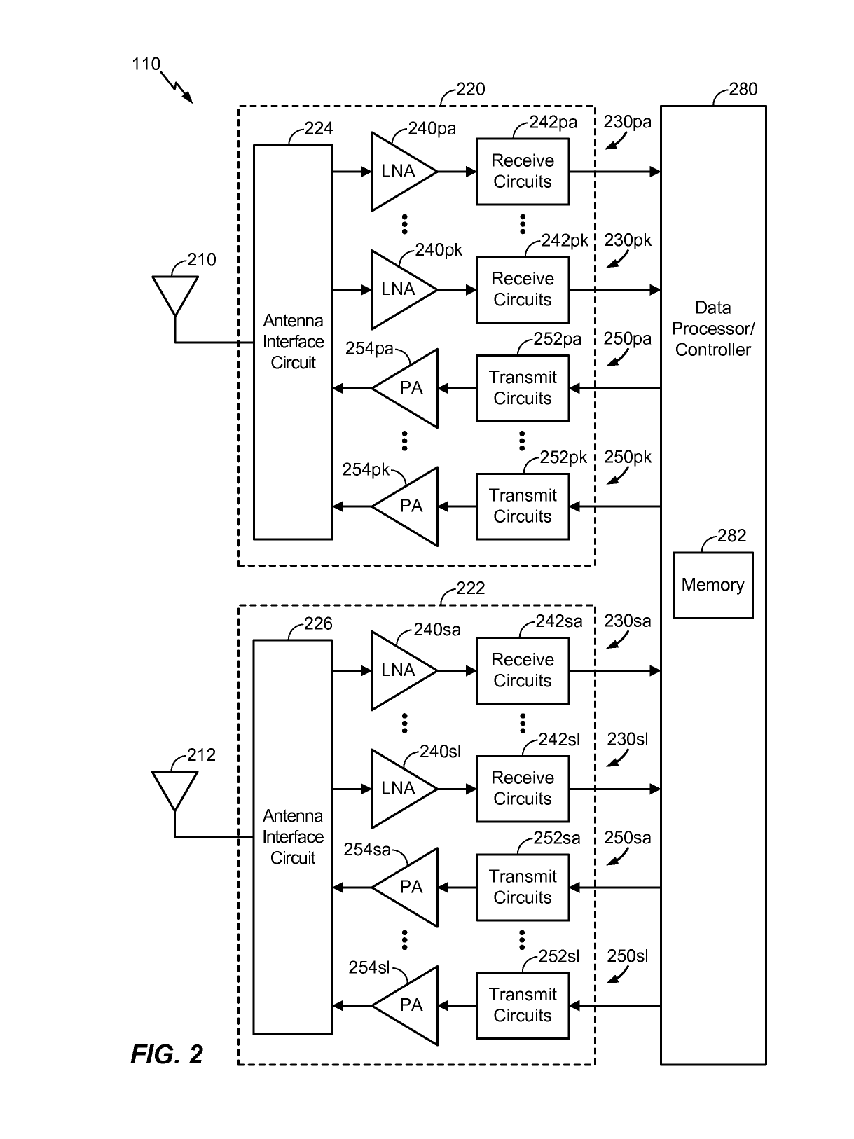

FIG. 2 shows a block diagram of an exemplary design of wireless device 110 in FIG. 1. In this exemplary design, wireless device 110 includes a transceiver 220 coupled to a primary antenna 210, a transceiver 222 coupled to a secondary antenna 212, and a data processor/controller 280. Transceiver 220 includes multiple (K) receivers 230pa to 230pk and multiple (K) transmitters 250pa to 250pk to support multiple frequency bands, multiple radio technologies, carrier aggregation, etc. Transceiver 222 includes multiple (L) receivers 230sa to 230s1 and multiple (L) transmitters 250sa to 250s1 to support multiple frequency bands, multiple radio technologies, carrier aggregation, receive diversity, multiple-input multiple-output (MIMO) transmission from multiple transmit antennas to multiple receive antennas, etc.

In the exemplary design shown in FIG. 2, each receiver 230 includes an LNA 240 and receive circuits 242. For data reception, antenna 210 receives signals from base stations and/or other transmitter stations and provides a received RF signal, which is routed through an antenna interface circuit 224 and presented as an input RF signal to a selected receiver. Antenna interface circuit 224 may include switches, duplexers, transmit filters, receive filters, matching circuits, etc. The description below assumes that receiver 230pa is the selected receiver. Within receiver 230pa, an LNA 240pa amplifies the input RF signal and provides an output RF signal. Receive circuits 242pa downconvert the output RF signal from RF to baseband, amplify and filter the downconverted signal, and provide an analog input signal to data processor 280. Receive circuits 242pa may include mixers, filters, amplifiers, matching circuits, an oscillator, a local oscillator (LO) generator, a phase locked loop (PLL), etc. Each remaining receiver 230 in transceivers 220 and 222 may operate in similar manner as receiver 230pa.

The receive circuits 242pa are configured to frequency shift signals that are communicated within the receive circuits 242pa to avoid or to reduce interference. For example, as described in further detail with respect to FIG. 3, a baseband control signal may be generated at a baseband portion of the receive circuits 242pa and used to control operation of a RF portion of the receive circuits 242pa. The control signal may be frequency modulated to avoid or reduce interference, such as interference due to NFC signaling at the wireless device 110.

In the exemplary design shown in FIG. 2, each transmitter 250 includes transmit circuits 252 and a power amplifier (PA) 254. For data transmission, data processor 280 processes (e.g., encodes and modulates) data to be transmitted and provides an analog output signal to a selected transmitter. The description below assumes that transmitter 250pa is the selected transmitter. Within transmitter 250pa, transmit circuits 252pa amplify, filter, and upconvert the analog output signal from baseband to RF and provide a modulated RF signal. Transmit circuits 252pa may include amplifiers, filters, mixers, matching circuits, an oscillator, an LO generator, a PLL, etc. A PA 254pa receives and amplifies the modulated RF signal and provides a transmit RF signal having the proper output power level. The transmit RF signal is routed through antenna interface circuit 224 and transmitted via antenna 210. Each remaining transmitter 250 in transceivers 220 and 222 may operate in similar manner as transmitter 250pa.

The transmit circuits 252pa are configured to frequency shift signals that are communicated within the transmit circuits 252pa to avoid or to reduce interference. For example, as described in further detail with respect to FIG. 3, a baseband control signal may be generated at a baseband portion of the transmit circuits 252pa and used to control operation of a RF portion of the transmit circuits 252pa. The control signal may be frequency modulated to avoid or reduce interference, such as interference due to NFC signaling at the wireless device 110.

FIG. 2 shows an exemplary design of receiver 230 and transmitter 250. A receiver and a transmitter may also include other circuits not shown in FIG. 2, such as filters, matching circuits, etc. All or a portion of transceivers 220 and 222 may be implemented on one or more analog integrated circuits (ICs), RF ICs (RFICs), mixed-signal ICs, etc. For example, LNAs 240 and receive circuits 242 may be implemented on one module, which may be an RFIC, etc. The circuits in transceivers 220 and 222 may also be implemented in other manners.

Data processor/controller 280 may perform various functions for wireless device 110. For example, data processor 280 may perform processing for data being received via receivers 230 and data being transmitted via transmitters 250. Controller 280 may control the operation of the various circuits within transceivers 220 and 222. A memory 282 may store program codes and data for data processor/controller 280. Data processor/controller 280 may be implemented on one or more application specific integrated circuits (ASICs) and/or other ICs.

Wireless device 110 may support multiple band groups, multiple radio technologies, and/or multiple antennas. Wireless device 110 may include a number of LNAs to support reception via the multiple band groups, multiple radio technologies, and/or multiple antennas.

FIG. 3 depicts an exemplary embodiment of a transceiver system 300 that is operable to adjust a frequency of a signal communicated between a baseband/intermediate frequency (BB/IF) chip 302 and a radio-frequency (RF) chip 304 via a cable 306 (e.g., a coaxial cable). For example, the transceiver system 300 may be implemented in the wireless device 110 of FIG. 1, such as within the receive circuits 242pa and the transmit circuits 242pa of FIG. 2. The BB/IF chip 302 includes a BB/IF transceiver circuit 310 configured to provide an IF signal 380 to an interface 315 that includes a triplexer 314. The BB/IF chip 302 also includes a high-frequency synthesizer 316 that provides a LO signal 382 to the triplexer 314 and a management modem 318 that provides a frequency modulated control signal 384 to the triplexer 314.

The transceiver circuit 310 includes a phase locked loop (PLL) 340 and a transmit path that includes a digital-to-analog (D/A) convertor 341 responsive to the PLL 340. A mixer 343 has an input coupled to the D/A convertor 341 and an output coupled to a switch 345. A receive path includes a mixer 344 having an input coupled to the switch 345 and an output coupled to an analog-to-digital (A/D) convertor 342 that is responsive to the PLL 340. The switch 345 is configured to selectively couple the transmit path to the triplexer 314 to send the IF signal 380 to the RF chip 304 or to couple the receive path to the triplexer 314 to receive an IF signal from the RF chip 304.

An oscillator 320 (e.g., a crystal oscillator) is coupled to the synthesizer 316 and provides a reference clock signal that is used by the synthesizer 316 to generate the LO signal 382. The LO signal 382 is provided to the management modem 318, to the triplexer 314, and to a frequency multiplier 312.

The frequency multiplier 312 is a variable frequency multiplier that is configured to output a signal that has a frequency that is “N” times the LO frequency of the LO signal 382. The value of N may be programmable and may be determined by the management modem 318. For example, the frequency multiplier 312 may include a non-linear, wide bandwidth buffer amplifier coupled to a bank of selectable band-pass filters that are tuned to filter harmonics of an input signal. For example, selection of a band-pass filter that passes the third harmonic of the input signal results in “x3” frequency multiplier operation. A signal output of the frequency multiplier 312 is provided to an input of the mixers 343, 344 and is used to generate the IF signal 380.

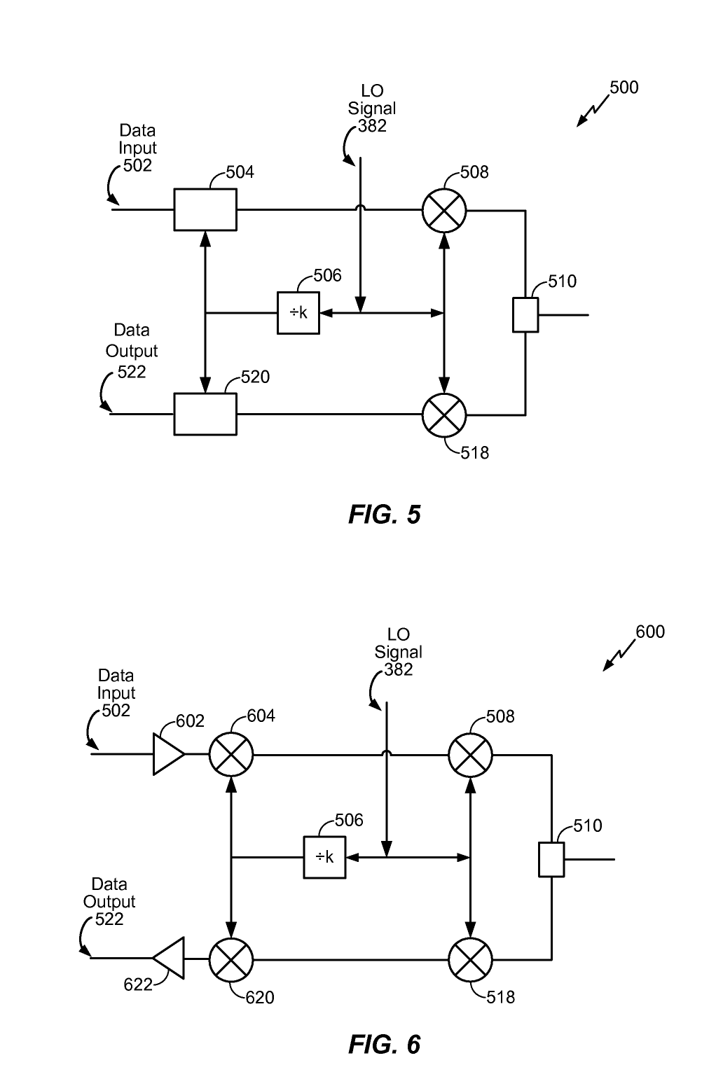

The management modem 318 includes a (baseband) control circuit 346 that generates a control signal. For example, the control signal may indicate an IF mode based on values of frequency multipliers or dividers, such as setting a value of N for the frequency multiplier 312. The management modem 318 also includes a modulator 348 to modulate the control signal to produce the frequency modulated control signal 384. Illustrative examples of the modulator 348 are described in further detail with respect to FIGS. 5-6.

The triplexer 314 is illustrated as including a first filter 322, a second filter 324, and a third filter 326 coupled to a combiner 328. The combiner 328 combines a first frequency band that includes the IF signal 380, a second frequency band that includes the LO signal 382, and a third frequency band that includes the modulated control signal 384, and provides a combined output signal to the cable 306. The triplexer 314 may have a configurable frequency characteristic. For example, one or more of the filters 322-326 may be a variable filter having an adjustable passband to accommodate frequency shifting of one or more signals transmitted over the cable 306. As another example, the triplexer 314 may represent a bank of selectable triplexers, each having different frequency characteristics.

The RF chip 304 includes a triplexer 334 coupled to the cable 306. The triplexer 334 has a first output to provide the IF signal 380 to a RF transceiver circuit 330, a second output to provide the LO signal 382 to a management modem 338 and to the RF transceiver 330, and a third output to provide the frequency modulated control signal 384 to the management modem 338. The triplexer 334 is illustrated as having a combiner 358 (e.g., a node). The combiner 358 is coupled to a first filter 352 that is configured to pass the IF signal 380, coupled to a second filter 354 that is configured to pass the LO signal 382, and coupled to a third filter 356 that is configured to pass the modulated control signal 384. One or more of the filters 352-356 may be a variable filter having an adjustable passband to accommodate frequency shifting of one or more signals transmitted over the cable 306. Although the triplexers 314 and 334 are described as having “inputs” and “outputs” for ease of description, it should be understood that each of the triplexers 314 and 334 may be a bi-directional passive devices that functions as a three-port to one-port frequency multiplexer.

The management modem 338 includes a demodulator 368 coupled to a control circuit 366. The demodulator 368 is configured to receive the frequency modulated control signal 384 and the LO signal 382 and to provide a demodulated control signal to the control circuit 366. The control circuit 366 is configured to control operation of the RF chip 304, such as by adjusting a multiplier value of an “xM” frequency multiplier 332.

The RF transceiver circuit 330 includes a switch 365 that selectively routes the IF signal 380 to a transmit path that includes a first mixer 363 and a first amplifier 361, such as a power amplifier, or that receives an IF signal from a receive path that includes a second mixer 364 and a second amplifier, such as a low noise amplifier (LNA). The amplifiers 361, 362 are selectively coupled to an antenna 372 via a switch 370. The first mixer 363 is configured to mix the IF signal 380 with a frequency multiplied version of the LO signal 382 that is output by the “xM” frequency multiplier 332 to generate an RF signal. The second mixer 364 is configured to mix a received RF signal with the output of the “xM” frequency multiplier 332 to generate an IF receive signal. The frequency multiplier 332 may be a variable frequency multiplier and may operate as described with respect to the “xN” frequency multiplier 312.

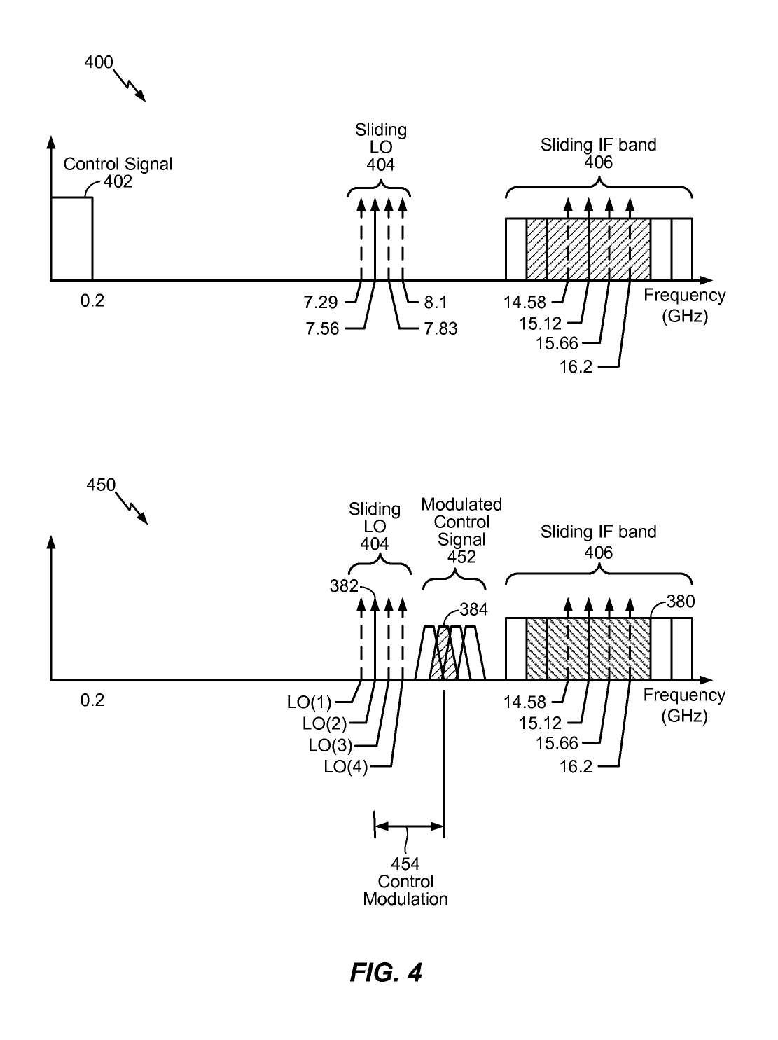

During operation, the control circuit 346 at the BB/IF chip 302 may control a frequency of the LO signal 382, multiplier values of the frequency multipliers 312 and 332 (e.g., the values of N and M may be determined by the control circuit 346), and a value of a frequency divider in the modulator 348 to generate signals in selected frequency bands to reduce interference. For example, one or more RF sensors may be included in the RF chip 304 and frequency modulation of the control signals may be dynamically adjusted based on RF sensor measurements to avoid or reduce interference. An example illustrating a frequency-adjusted modulated control signal 384 is depicted in FIG. 4.

FIG. 4 illustrates an exemplary embodiment of an electromagnetic spectrum 450 of signal components in a link between the BB/IF chip 302 and the RF chip 304 via the cable 306 of FIG. 3, as compared to an electromagnetic spectrum 400 of signal components in a link between a baseband device and an RF device in a superheterodyne transceiver that does not perform frequency adjustment of control signals.

The electromagnetic spectrum 400 includes control signals 402, a set of available local oscillator (LO) signals 404 of a sliding IF system, and a set of intermediate frequency (IF) bands 406 that may be provided via a link such as a cable between a BB/IF chip and a RF chip. A selected LO signal of the set of LO signals 404 is illustrated as a solid arrow, and a corresponding IF band of the set of IF bands 406 is illustrated as hatched. As illustrated, the control signals 402 occupy a frequency band from 0-200 MHz and may be subject to interference from near-field communication (NFC) transmissions that occur at 13 MHz.

The electromagnetic spectrum 450 illustrates frequency bands for the set of LO signals 404 and the set of IF bands 406 at the cable 306 of FIG. 3. A set of modulated control signals 452 is located at a frequency band between the set of LO signals 404 and the set of IF bands 406. In the illustrated example, the LO signal 382 is a second LO (e.g., LO(2)) of the set of LO signals 404, the IF signal 380 is a second IF band (e.g., IF(2)) of the set of IF bands 406, and the modulated control signal 384 is a second modulated control signal of the set of modulated control signals 452. A frequency offset of the modulated control signal 384 from the LO signal 382 is illustrated as control modulation 454. Potential interference of the (unmodulated) control signal 402 with NFC signals is avoided using the set of frequency modulated control signals 452. In addition, via selection of LO frequency, N, and M of FIG. 3, other potential sources of interference may be avoided or reduced by frequency shifting one or more of the LO signals 404 and the IF bands 406.

FIG. 5 illustrates an exemplary embodiment of a circuit 500 that may be implemented in the modulator 348 and/or the demodulator 368 of FIG. 3. The circuit 500 includes an on-off keying (OOK) modulator 504 coupled to an RF upconverter 508 and coupled to a “+k” frequency divider 506. A switch 510 is coupled to the RF upconverter 508 and to an RF downconverter 518. An OOK demodulator 520 is coupled to the RF downconverter 518 and to the frequency divider 506.

The OOK modulator 504 is configured to receive a data input 502, such as control signals from the control circuit 346 of FIG. 3, and to provide an on-off keying modulated signal to the RF upconverter 508. The RF upconverter 508 is configured to mix an output of the OOK modulator 504 with a LO signal, such as the LO signal 382 of FIG. 3. An output of the RF upconverter 508 is provided to the switch 510 to be selectively output. For example, the output of the RF upconverter 508 may be the modulated control signal 384 output to the triplexer 314 of FIG. 3.

The RF downconverter 518 is configured to receive an input signal from the switch 510 and to mix the input signal with the LO signal (e.g., the LO signal 382). The OOK demodulator 520 is configured to demodulate an output of the RF downconverter 518 to generate a data output signal 522.

The OOK modulator 504 and the OOK demodulator 520 are configured to perform modulation and demodulation, respectively, at a rate determined by an output of the frequency divider 506. The frequency divider 506 may be a variable frequency divider such that a value of “k” may be programmable or otherwise selectable, such as by the control circuit 346 of FIG. 3. For example, adjusting the value of “k” may cause variation in the control modulation 454 of FIG. 4, enabling frequency shifting of the modulated control data 382 to reduce or avoid interference of signals communicated via the cable 306.

FIG. 6 illustrates another exemplary embodiment of a circuit 600 that may be implemented in the modulator 348 and/or the demodulator 368 of FIG. 3. The circuit 600 includes the “+k” frequency divider 506, the RF upconverter 508, the switch 510, and the RF downconverter 518 of FIG. 5. The circuit 600 includes an input amplifier 602 coupled to an IF upconverter 604 and an output amplifier 622 coupled to an IF downconverter 620. The IF upconverter 604 is coupled to the RF upconverter 508 and to the “+k” frequency divider 506. The IF downconverter 620 is coupled to the RF downconverter 518 and to the “+k” frequency divider 506.

During modulation, the amplified data input signal 502 is mixed at the IF upconverter 604 with an IF signal. The IF signal has an IF frequency that is equal to the LO signal frequency divided by “k.” Mixing the IF signal with the amplified data input signal 502 generates an IF control signal that is provided to the RF upconverter 508. During demodulation, an IF control signal from the RF downconverter 518 is mixed at the IF downconverter 620 with the IF signal having the frequency equal to the LO signal frequency divided by “k” to generate a data signal that is provided to the output amplifier 622. Adjusting the value of “k” changes the control modulation 454 of FIG. 4, enabling frequency shifting of the modulated control data 382 to reduce or avoid interference of signals communicated via the cable 306.

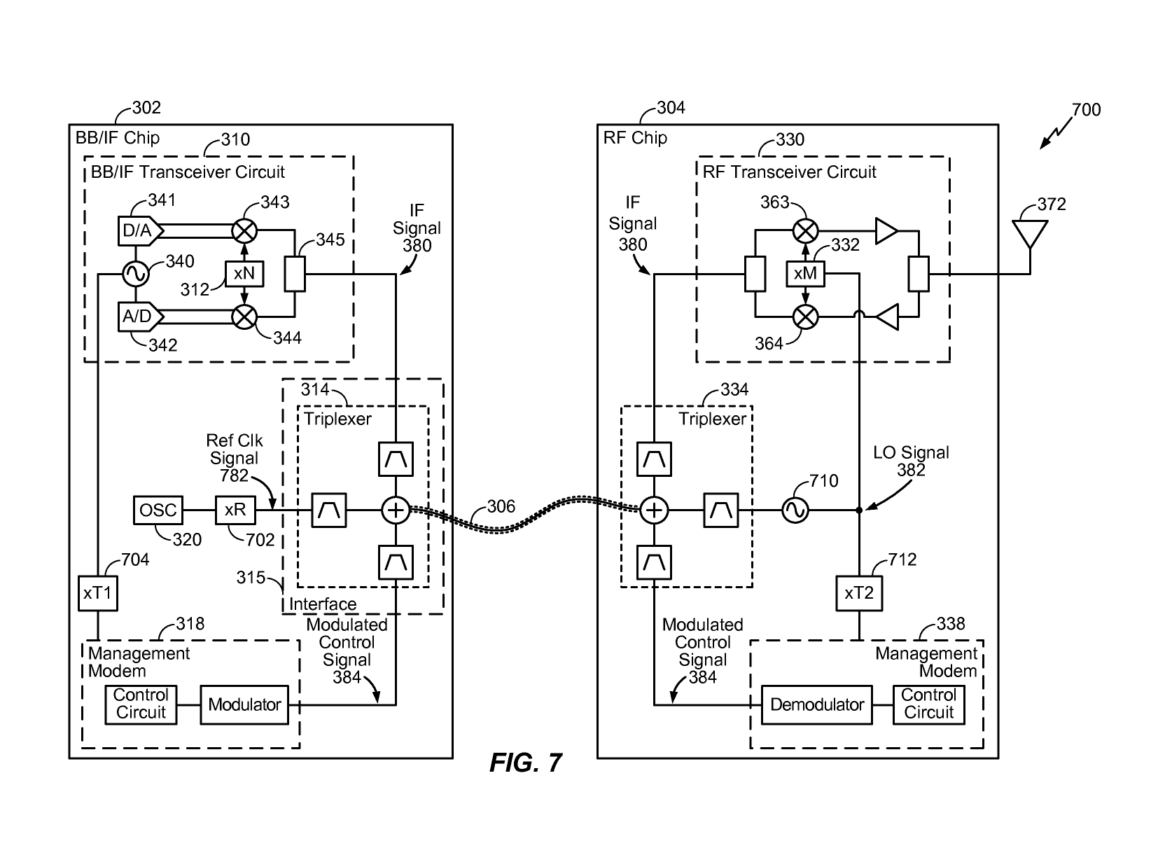

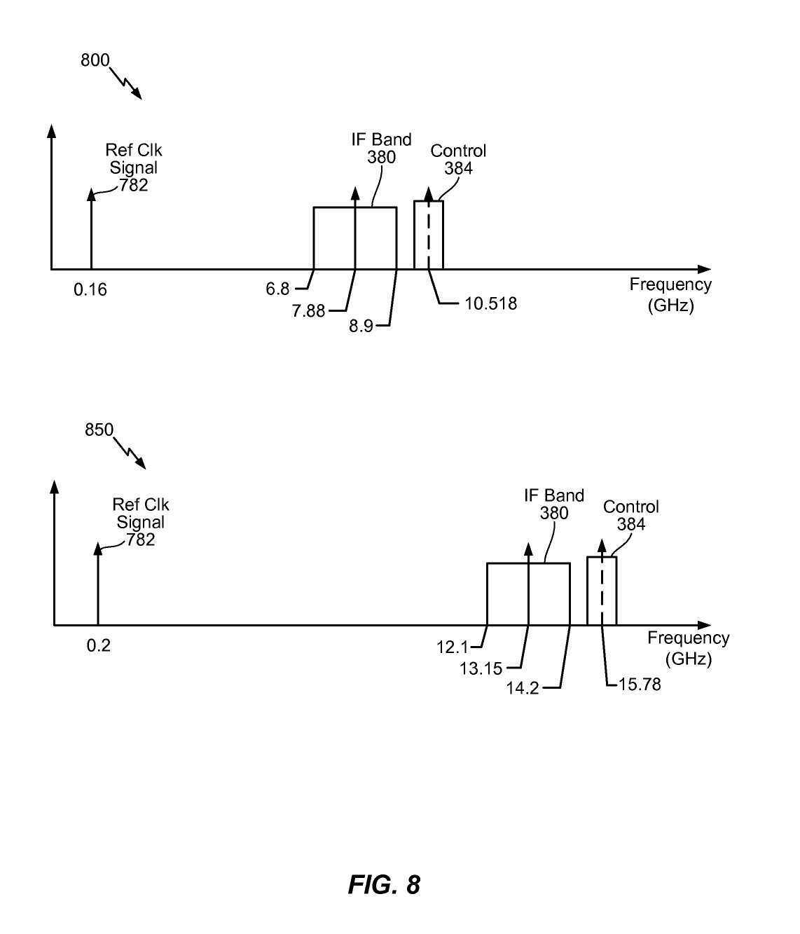

FIG. 7 depicts another exemplary embodiment of a transceiver system 700 that is operable to adjust a frequency of a signal communicated between the baseband/intermediate frequency (BB/IF) chip 302 and the radio-frequency (RF) chip 304 via the cable 306 of FIG. 3. The BB/IF chip 302 includes the BB/IF transceiver circuit 310, the interface 315 including the triplexer 314, the management modem 318, and the oscillator 320 of FIG. 3. However, rather than generating an IF LO signal at a synthesizer on the BB/IF chip 302, an output of the oscillator 320 is provided to a “xR” variable frequency multiplier 702 to generate a reference clock signal 782. The reference clock signal 782 is provided to the triplexer 314 to be sent to the RF chip 304 via the cable 306.

The PLL 340 generates an output signal that is provided to the “xN” frequency multiplier 312. An output of the “xN” frequency multiplier 312 is provided to the mixers 343 and 344. In addition, the output signal of the PLL 340 is provided to an “xT1” variable frequency multiplier 704. An output of the “xT1” frequency multiplier 704 is provided to the management modem 318 (e.g., to function as the LO signal of FIGS. 5-6 for modulation and demodulation of control signals).

The RF chip 304 includes the triplexer 334, the RF transceiver circuit 330, and the management modem 338 of FIG. 3. A RF synthesizer 710 is coupled to receive the reference clock signal 782 from the triplexer 334 and to generate the LO signal 382. The LO signal 382 is provided to the “xM” frequency multiplier 332 of the RF transceiver circuit 330 to generate an RF LO signal for the mixers 363, 364. The LO signal 382 is also provided to the management modem 338 via an “xT2” variable frequency multiplier 712.

During operation, the control circuit 346 at the BB/IF chip 302 may control multiplier values of the “xN” frequency multiplier 312, the “xR” frequency multiplier 702, and the “xT1” frequency multiplier 704 at the BB/IF chip 302. In addition, the control circuit 302 may select multiplier values of the “xM” frequency multiplier 332 and the “xT2” frequency multiplier 712 of the RF chip 304.

A frequency of the LO signal 382 may be expressed as:

LO_{—}rf=(F_{—}rf−LO_{—}bb*N)/M,

where LO_rf is the frequency of the LO signal 382, F_rf is the carrier frequency of the RF signal, LO_bb is the frequency of the output of the PLL 340 on the BB/IF chip 302, M is the multiplier value of the “xM” frequency multiplier 332, and N is the multiplier value of the “xN” frequency multiplier 312.

A relationship between the multiplier values T1 and T2 may be expressed as:

LO_{—}bb*T1=LO_{—}rf*T2,

where T1 is the multiplier value of the “xT1” frequency multiplier 704 and T2 is the multiplier value of the “xT2” frequency multiplier 712.

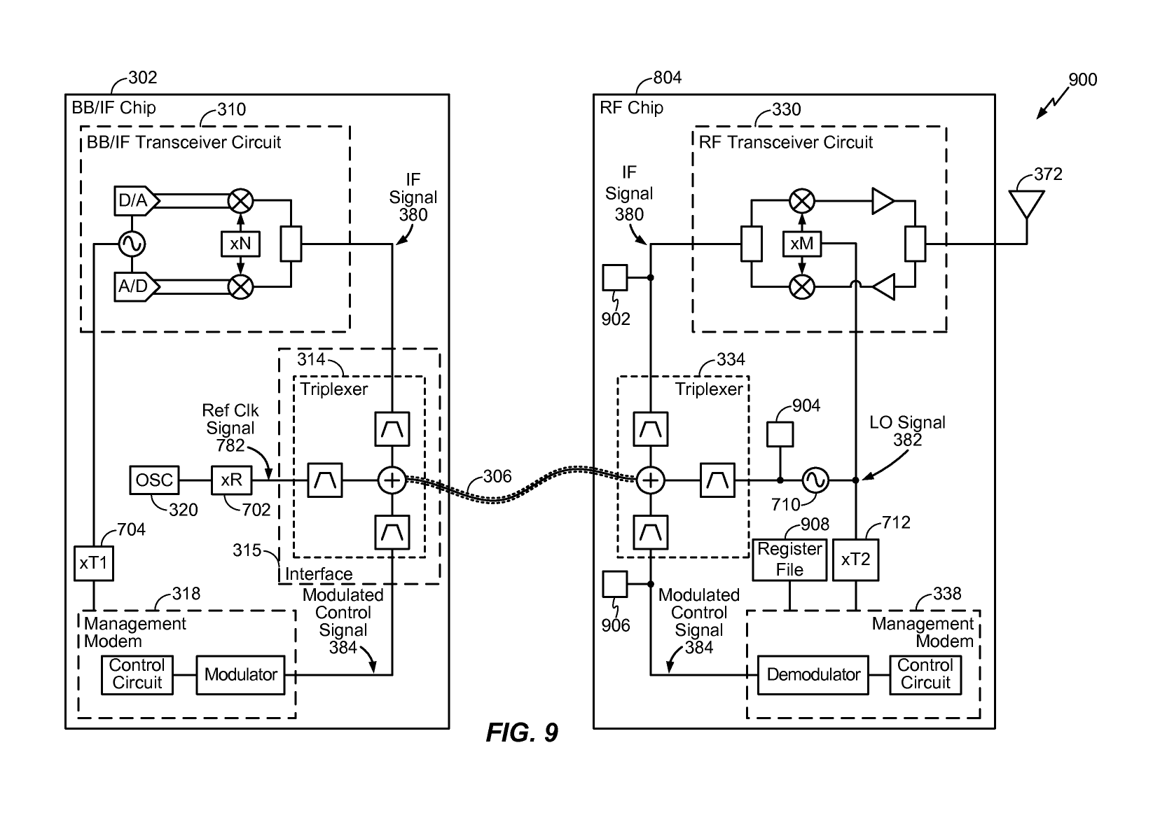

At least partially based on the above relationships, the control circuit 346 at the BB/IF chip 302 may control a frequency of the PLL 340, multiplier values of the frequency multipliers 312, 332, 702, 704, and 712 (e.g., the values of N, M, R, T1, and T2 may be determined by the control circuit 346), and a frequency divider value of a frequency divider in the modulator 348 (e.g., the value of k) to generate signals in selected frequency bands to reduce interference. For example, as described in further detail with respect to FIG. 9, one or more RF sensors may be included in the RF chip 304 and frequency modulation of the control signals may be dynamically adjusted based on RF sensor measurements to avoid or reduce interference. An example illustrating multiple sets of frequency-adjusted signals is depicted in FIG. 8.

FIG. 8 illustrates a first exemplary embodiment of an electromagnetic spectrum 800 of signal components communicated between the BB/IF chip 302 and the RF chip 304 via the cable 306 of FIG. 7 and a second exemplary embodiment of an electromagnetic spectrum 850 of signal components communicated via the cable 306. In the examples of FIG. 8, the BB LO frequency (LO_bb) is 2.6296 GHz, the RF carrier (F_rf) is 60.48 GHz, and the oscillator 320 has a frequency of 40 MHz.

The electromagnetic spectrum 800 represents a first frequency plan where N=3, M=5, T1=4, T2=1, and R=4. The reference clock signal 782 is at approximately 160 MHz, the IF signal 380 is represented as a band centered at approximately 7.88 GHz, and the frequency modulated control signal 384 is centered at approximately 10.518 GHz.

The electromagnetic spectrum 850 represents a second frequency plan where N=5, M=6, T1=6, T2=2, and R=5. In this example, the reference clock signal 782 is at approximately 200 MHz, the IF signal 380 is represented as a band centered at approximately 13.15 GHz, and the frequency modulated control signal 384 is centered at approximately 15.78 GHz.

When mutual interference is observed (e.g., via sensors at the RF chip 304) or inferred (e.g., based on activity of other active transceivers in or near the device), switching between the frequency plans may reduce or eliminate the interference. Although FIG. 8 depicts two frequency plans, more than two frequency plans may be used. For example, the management modem 318 may select from among multiple frequency plans to reduce interference of spectrum components.

FIG. 9 illustrates an exemplary embodiment of a system 900 that includes the BB/IF chip 302 and the RF chip 304 of FIG. 7 coupled by the cable 306. The RF chip 304 includes RF sensors 902, 904, and 906 that are coupled to detect interference at the IF signal port, the reference clock signal port, and the modulated control signal port, respectively, of the triplexer 334. Measurement data and/or other data of the RF sensors 902-906 is routed to a register file 908 that is accessible to the management modem 338. Data from the register file 908 may be sent to the management modem 318 as modulated control data to enable the management modem 318 to process the data to detect interference. In an alternative implementation, the management modem 338 may process data in the register file 908 and send processing results to the management modem 318. The measurement data may be used to detect interference at particular frequencies or frequency bands so that the management modem 318 can select parameter values that frequency-shift signal components to reduce or avoid the particular frequencies or frequency bands of the detected interference, such as described with respect to FIG. 8.

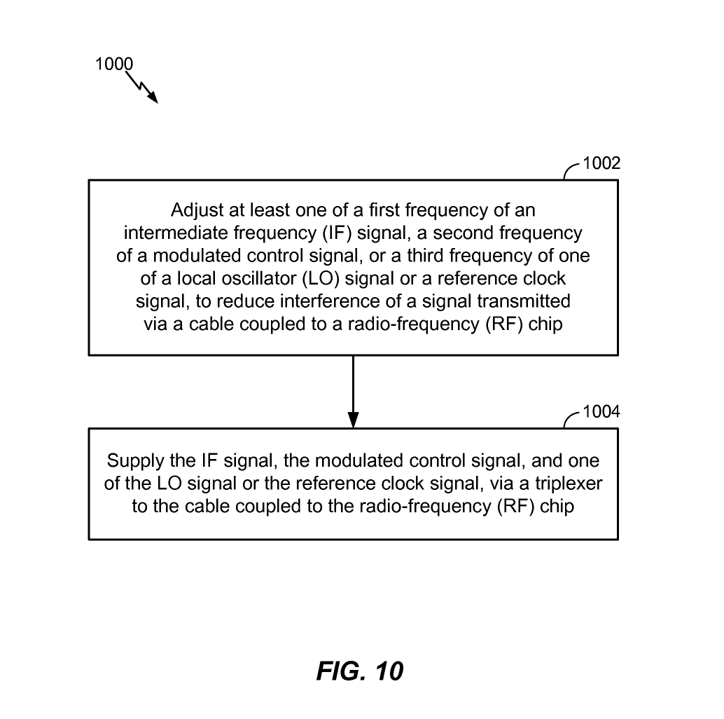

FIG. 10 depicts an exemplary embodiment of a method 1000 of frequency adjusting of a signal. The method 1000 may be performed at a transceiver that communicates signals, such as signals communicated between a baseband device and an RF device. For example, the method 1000 may be performed by the management modem 318 of FIG. 3, FIG. 7, or FIG. 9.

The method 1000 includes adjusting at least one of a first frequency of an intermediate frequency (IF) signal, a second frequency of a modulated control signal, or a third frequency of a local oscillator (LO) signal or a reference clock signal, to reduce interference of a signal transmitted via a cable coupled to a radio-frequency (RF) chip, at 1002. For example, adjusting the first frequency may include adjusting a value of “N” of the “xN” frequency multiplier circuit 312 of FIG. 3, FIG. 7, or FIG. 9. As another example, adjusting the second frequency may include adjusting a frequency division value of a variable frequency divider in a modulator, such as the frequency division value “k” of the “+k” variable frequency divider 506 of FIG. 5 or FIG. 6. As another example, adjusting the third frequency may include adjusting the frequency multiplier value “R” of the “xR” variable frequency multiplier 702 of the reference clock circuit of FIG. 7 or FIG. 9.

The IF signal, the modulated control signal, and one of the LO signal or the reference clock signal are supplied via a triplexer to the cable coupled to the radio-frequency (RF) chip, at 1004. For example, the IF signal, the modulated control signal, and one of the LO signal or the reference clock signal may be frequency multiplexed via the triplexer 314 of FIG. 3, FIG. 7, or FIG. 9, and sent to the RF chip 304 via the cable 306. To illustrate, the triplexer may be adjustable and one of more passbands of the triplexer may be controlled to pass the one or more adjusted frequencies.

Adjusting at least one of the first frequency, the second frequency, or the third frequency may include selecting a frequency plan of a set of frequency plans at least partially based on a frequency of interference. For example, the first frequency plan 800 or the second frequency plan 850 of FIG. 8 may be selected from a set of multiple frequency plans to avoid interference. To illustrate, if interference is detected or predicted to be at 8 GHz, the second frequency plan 850 may be selected. Alternatively, if interference is detected or predicted to be at 13 GHz, the first frequency plan 800 may instead be selected.

In some implementations, frequency adjustment may be performed during production of a device that includes the RF chip based on information of mutual interferences predicted for the device. Alternatively, or in addition, frequency adjustment may be performed automatically during operation of the device based on a mode of operation of the device. For example, a controller may identify a mode of operation based on active components of the device (e.g., GPS, LTE, NFC) and may select a set of parameters determined to reduce or avoid interference based on the device's mode of operation. To illustrate, in a mode of operation where the transceiver system 700 of FIG. 7 is operating concurrently with a second transceiver that generates signals at a particular frequency, a set of parameters that corresponds to the mode of operation may cause signals of the transceiver system 700 to be shifted to frequencies other than the particular frequency to reduce mutual interference. As another example, the device may include power sensors that may detect interference activity, such as the RF sensors 902-206 of FIG. 9,

Although the transceiver systems of FIG. 3, FIG. 7, and FIG. 9 are illustrated as having a superheterodyne configuration, in other embodiments one or more of the transceiver systems may have an alternative configuration. For example, modulation of the control signal or other signals may be performed by a direct conversion or zero-IF (ZIF) transceiver. Although the transceiver systems of FIG. 3, FIG. 7, and FIG. 9 are described as having a triplexer (e.g., a passband-adjustable triplexer or a bank of selectable triplexers) in the interface 315, in other embodiments one or more of the transceiver circuits may not include a triplexer. For example, the interface 315 may perform frequency multiplexing of signals (e.g., using one or more diplexers) or may use dedicated lines for each signal without frequency multiplexing of multiple signals onto a single line.

In conjunction with the described embodiments, an apparatus includes means for frequency modulating a control signal at a baseband device. For example, the means for frequency modulating may include the modulator 348 of FIG. 3, FIG. 7, or FIG. 9, the circuit 500 of FIG. 5, the circuit 600 of FIG. 6, another circuit configured to perform frequency modulation, or any combination thereof. The apparatus also includes means for transmitting the frequency modulated control signal via a wired communication path to a radio-frequency (RF) device. For example, the means for transmitting may include the interface 315 of FIG. 3, FIG. 7, or FIG. 9, the triplexer 314 of FIG. 3, FIG. 7, or FIG. 9, another circuit configured to transmit a signal, or any combination thereof.

The apparatus may also include means for adjusting at least one of a first frequency of an intermediate frequency (IF) signal, a second frequency of the frequency modulated control signal, or a third frequency of one of a local oscillator (LO) signal or a reference clock signal, to reduce interference of a signal transmitted via a cable coupled to the radio-frequency (RF) device. For example, the means for adjusting may include the control circuit 346 of FIG. 3, FIG. 7, or FIG. 9, another circuit configured to adjust frequencies, or any combination thereof. In an exemplary embodiment, the means for adjusting is configured to adjust the first frequency by adjusting a frequency multiplier value of the “xN” frequency multiplier 312 of FIG. 3, FIG. 7, or FIG. 9 and/or by adjusting a frequency of the PLL 340 of FIG. 3, FIG. 7, or FIG. 9. In an exemplary embodiment, the means for adjusting is configured to adjust the second frequency by adjusting the synthesizer 316 of FIG. 3, by adjusting a frequency divider value of the frequency divider 506 of FIG. 5 or FIG. 6, by adjusting a frequency multiplier value of the “xT1” frequency multiplier 704 of FIG. 7 or FIG. 9, or any combination thereof. In an exemplary embodiment, the means for adjusting is configured to adjust the third frequency by adjusting the synthesizer 316 of FIG. 3, by adjusting a frequency multiplier value of the “xR” frequency multiplier 702 of FIG. 7 or FIG. 9, or any combination thereof.

The apparatus may also include means for supplying the IF signal, the frequency modulated control signal, and one of the LO signal or the reference clock signal to the cable coupled to the radio-frequency (RF) device. For example the means for supplying may include the interface 315 of FIG. 3, FIG. 7, or FIG. 9, the triplexer 314 of FIG. 3, FIG. 7, or FIG. 9, one or more of the filters 322-326 of FIG. 3, FIG. 7, or FIG. 9, the combiner 328 of FIG. 3, FIG. 7, or FIG. 9, or any combination thereof.

In conjunction with the described embodiments, a radio-frequency (RF) apparatus includes means for transceiving a radio-frequency (RF) signal. For example, the means for transceiving may include the RF transceiver circuit 330 of FIG. 3, FIG. 7, or FIG. 9, another circuit configured to transceiver an RF signal, or any combination thereof. The RF apparatus also includes means for receiving a frequency modulated control signal from a baseband device and for generating the control signal. For example, the means for receiving the frequency modulated control signal and generating the control signal may include the demodulator 368 of FIG. 3, FIG. 7, or FIG. 9, the circuit 500 of FIG. 5, the circuit 600 of FIG. 6, another circuit configured to receive a frequency modulated control signal and to generate a control signal, or any combination thereof. The RF apparatus includes means for controlling operation of the RF transceiver based on the control signal. For example, the means for controlling may include the control circuit 366 of FIG. 3, FIG. 7, or FIG. 9, another circuit configured to control operation of the RF transceiver based on a control signal, or any combination thereof.

In conjunction with the described embodiments, a radio-frequency integrated circuit (RFIC) includes means for synthesizing a radio-frequency (RF) local oscillator (LO) signal. For example, the means for synthesizing may include the RF synthesizer 710 of FIG. 7 or FIG. 9, another circuit configured to synthesize an RF signal, or any combination thereof. The RFIC includes means for transceiving. The means for transceiving is coupled to receive the local oscillator (LO) signal from the means for synthesizing. For example, the means for transceiving may include the RF transceiver circuit 330 of FIG. 7 or FIG. 9, another circuit configured to transceive an RF signal, or any combination thereof. The RFIC also includes means for controlling operation of the means for transceiving. The means for controlling is coupled to receive the LO signal. For example, the means for controlling may include the management modem 338 of FIG. 7 or FIG. 9, another circuit configured to control operation of an RF transceiver, or any combination thereof. In an exemplary embodiment, the RFIC includes means for receiving a reference clock signal via a cable and providing the reference clock signal to the means for synthesizing. For example the means for receiving and providing may include the triplexer 334 of FIG. 7 or FIG. 9.

Those of skill would further appreciate that the various illustrative logical blocks, configurations, modules, circuits, and algorithm steps described in connection with the embodiments disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal. In an exemplary embodiment, the processor and the storage medium may be included in the management modem 318 of FIG. 3.

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. An apparatus comprising:
a modulator configured to frequency modulate a control signal at a baseband device; and
an interface configured to transmit the frequency modulated control signal via a wired communication path to a radio-frequency (RF) device.

2. The apparatus of claim 1, wherein the modulator is configurable to modify the frequency modulation of the control signal and wherein the wired communication path comprises a cable.

3. The apparatus of claim 2, wherein the modulator comprises a variable frequency divider coupled to receive a local oscillator signal.

4. The apparatus of claim 1, further comprising an intermediate frequency (IF) transceiver circuit coupled to the interface.

5. The apparatus of claim 4, further comprising:
a control circuit configured to generate the control signal; and
a reference clock circuit coupled to a synthesizer, wherein a local oscillator (LO) output of the synthesizer is coupled to the IF transceiver circuit via a variable frequency multiplier, and wherein the variable frequency multiplier is adjustable by the control circuit.

6. The apparatus of claim 5, wherein the LO output of the synthesizer is coupled to the interface to provide the LO output to the RF device.

7. The apparatus of claim 1, further comprising a reference clock circuit having an output coupled to the interface to provide a reference clock signal to the RF device.

8. The apparatus of claim 1, wherein the reference clock circuit comprises a variable frequency multiplier.

9. The apparatus of claim 1, further comprising a control circuit configured to generate the control signal, and wherein the control circuit is further configured to determine a frequency multiplier value of a variable frequency multiplier of the RF device.

10. The apparatus of claim 1, wherein the interface comprises a triplexer having an output to provide a frequency multiplexed signal to the RF device via the cable.

11. The apparatus of claim 10, wherein the triplexer further includes a first input coupled to an intermediate frequency (IF) transceiver, a second input coupled to a reference clock circuit or to a synthesizer, and a third input coupled to the modulator.

12. An apparatus comprising:
means for frequency modulating a control signal at a baseband device; and
means for transmitting the frequency modulated control signal via a wired communication path to a radio-frequency (RF) device.

13. The apparatus of claim 12, wherein the wired communication path includes a cable and further comprising:
means for adjusting at least one of a first frequency of an intermediate frequency (IF) signal, a second frequency of the frequency modulated control signal, or a third frequency of one of a local oscillator (LO) signal or a reference clock signal, to reduce interference of a signal transmitted via the cable coupled to the radio-frequency (RF) device; and
means for supplying the IF signal, the frequency modulated control signal, and one of the LO signal or the reference clock signal to the cable coupled to the radio-frequency (RF) device.

14. The apparatus of claim 13, wherein the means for adjusting is configured to adjust the second frequency by adjusting a frequency division value of a variable frequency divider in the means for frequency modulating, and wherein the means for adjusting is configured to adjust the third frequency by adjusting a frequency multiplier value of a variable frequency multiplier of a reference clock circuit.

15. The method of claim 13, wherein the means for adjusting is configured to select a frequency plan of a set of frequency plans at least partially based on a frequency of the interference.

16. A radio-frequency integrated circuit comprising:
a radio-frequency (RF) synthesizer;
an RF transceiver coupled to receive a local oscillator (LO) signal from the RF synthesizer; and
a control modem coupled to receive the LO signal.

17. The radio-frequency integrated circuit of claim 16, further comprising a triplexer configured to receive a reference clock signal via a cable and coupled to provide the reference clock signal to the synthesizer.

18. The radio-frequency integrated circuit of claim 17, wherein the triplexer is further configured to receive an intermediate frequency (IF) signal from a baseband (BB)/IF device via the cable and to receive modulated control signals from the BB/IF device via the cable.

19. A radio-frequency integrated circuit comprising:
means for synthesizing a radio-frequency (RF) local oscillator (LO) signal;
means for transceiving, wherein the means for transceiving is coupled to receive the LO signal from the means for synthesizing; and
means for controlling operation of the means for transceiving, wherein the means for controlling is coupled to receive the LO signal.

20. The radio-frequency integrated circuit of claim 19, further comprising means for receiving a reference clock signal via a cable and providing the reference clock signal to the means for synthesizing.

21. The radio-frequency integrated circuit of claim 20, wherein the means for receiving is further configured to receive an intermediate frequency (IF) signal from a baseband (BB)/IF device via the cable and to receive modulated control signals from the BB/IF device via the cable.
